(19) United States
(12) Patent Application Publication
(10) Pub. No.: US 2008/0317121 A1
(43) Pub. Date: Dec. 25, 2008

(54) Rate control methods and devices

(75) Inventor: Wei-Jen Chen, Taipei City (TW)

Correspondence Address: BIRCH STEWART KOLASCH & BIRCH, PO BOX 747, FALLS CHURCH, VA, 22040-0747, US

(73) Assignee: InterVideo, Digital Technology Corporation

(21) Appl. No.: 12/007,839

(22) Filed: Jan. 16, 2008

(30) Foreign Application Priority Data
Jun. 22, 2007 (CN) 200710112067.4

(51) Int. Cl. H04N 7/26

(52) U.S. Cl. 375/240.03; 375/240.28; 375/E07.139

(57) ABSTRACT

Rate control methods and devices for use in a video encoding device supporting at least one core are provided. First, a sequence of frames is received. A plurality of threads are created according to the number of the at least one core. The threads are employed to encode at least one frame of the received frames, simultaneously. The frames in the sequence are then encoded according to the encoding results corresponding to the at least one frame.

### BACKGROUND OF THE INVENTION

1. Field of the Invention

The disclosure relates generally to rate control, and, more particularly to rate control methods and devices that simultaneously encode at least one video frame.

2. Description of the Related Art

In the Digital Age, digital content has become a common part of most human's lives with increased ownership of computers and consumer electronic products, and daily interaction with network systems. Of digital content, size and quality are two important considerations for transmission, especially for digital videos. For digital videos to be carried, transmitted or used in various applications, compression technologies must be applied thereof, to reduce data size under acceptable quality requirements.

MPEG (Moving Picture Experts Group) is a popular algorithm standard for compression and storage of digital video. MPEG algorithm defines rules for encoding and decoding of bit streams. A video encoder determines frame encoding types and uses the best prediction mode among frames. An important task of the video encoder is rate control. A successful rate control during the encoding process will improve video quality after the video is decoded, and maintain the output bit rate within a permissible range. It is noted that, rate control is commonly known for persons with ordinary skill in the art, and related background and details are omitted for brevity.

Generally, a MPEG frame is composed of macro blocks (MB). For conventional rate control, the video encoder encodes the frames in order. Rate control is performed based on the level of macro blocks, from top to bottom, and left to right of a frame. For example, FIGS. 1A and 1B illustrate two successive frames F1 and F2, with macro blocks 1˜16 and 17˜32, respectively. Conventionally, the encoding order of macro blocks in frames is from macro block 1 of frame F1 to macro block 16 of frame F1, and from macro block 17 of frame F2 to macro block 32 of frame F2, as shown in FIG. 2.

Recently, advanced processing devices, such as devices supporting Hyper-Threading technology, Multi-Core technology and/or multi-tasking OS (Operating System) can simultaneously run multiple tasks. Conventional rate control methods and devices cannot fully utilize the computing power of the advanced processing devices.

### BRIEF SUMMARY OF THE INVENTION

Rate control methods and devices are provided.

In an embodiment of a rate control method for use in a video encoding device supporting at least one core, a sequence of frames is received. A plurality of threads are created according to the number of the at least one core of the video encoding device. The threads are employed to encode at least one frame of the received frames, simultaneously. The frames in the sequence are then encoded according to the encoding results corresponding to the at least one frame.

An embodiment of a rate control device supporting at least one core comprises a reception unit and a processing unit. The reception unit receives a sequence of frames. The processing unit creates a plurality of threads according to the number of the at least one core. The processing unit encodes at least one frame of the received frames using the threads, simultaneously, and then encodes the frames in the sequence according to the encoding results corresponding to the at least one frame.

Rate control method may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIGS. 1A and 1B illustrate two successive frames;

FIG. 2 is a schematic diagram illustrating the encoding order of macro blocks in conventional rate control;

FIG. 3 is a schematic diagram illustrating an embodiment of a rate control device according to the invention;

FIG. 4 is a schematic diagram illustrating an embodiment of a storage unit according to the invention;

FIG. 5 is a schematic diagram illustrating the frame order in MPEG;

FIG. 6 is a flowchart of an embodiment of a rate control method according to the invention;

FIG. 7 is a schematic diagram illustrating an embodiment of encoding according to the rate control method of the invention;

FIG. 8 is a flowchart of an embodiment of an example of rate control according to the invention;

FIG. 9 is a schematic diagram illustrating an embodiment of the encoding order of macro blocks in the rate control according to the invention;

FIG. 10 is a schematic diagram illustrating an embodiment of a top frame and a bottom frame of a frame according to the invention;

FIG. 11 is a schematic diagram illustrating an embodiment of the encoding order of macro blocks in the rate control for the frame in FIG. 10 according to the invention;

FIG. 12 is a flowchart of an embodiment of an example of rate control according to the invention;

FIG. 13 is a flowchart of an embodiment of an example of rate control according to the invention;

FIG. 14 is a schematic diagram illustrating an example of MPEG frames; and

FIGS. 15A to 15G are schematic diagrams illustrating an encoding process for the frames in FIG. 14.

### DETAILED DESCRIPTION OF THE INVENTION

Rate control methods and devices are provided.

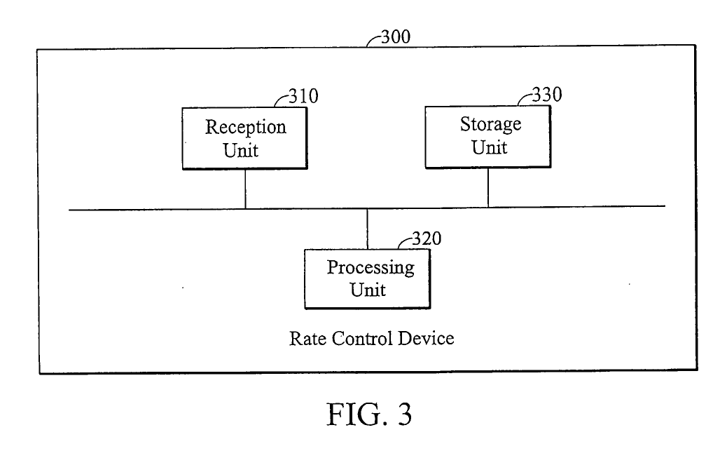

FIG. 3 is a schematic diagram illustrating an embodiment of a rate control device according to the invention.

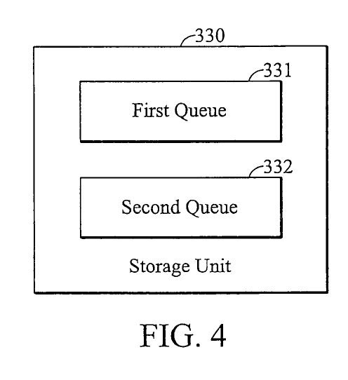

The rate control device 300 comprises a reception unit 310, a processing unit 320, and a storage unit 330. It is understood that, the rate control device 300 is in a video encoding device (not shown) supporting at least one core. The reception unit 310 receives a sequence of frames. The processing unit 320 determines the encoding type of the frames, that is, determines the type of respective frame, and performs corresponding encoding procedures. The storage unit 330 temporarily stores the frames received by the reception unit 310. It is understood that, in some embodiments, the storage unit 330 comprises a first queue 331 and a second queue 332, as shown in FIG. 4. The use of the first queue 331 and the second queue 332 is discussed later.

In this embodiment, the processing unit 320 can encode frames according to MPEG algorithm. Three types of frames, I, P and B frames are defined by MPEG. The I frame is internally encoded, that is, no macro block in the I frame refers to another frame. In the I frame, the encoding data is independently generated and without reference to other frames. During decoding, the I frame can be decoded without data from other frames. In the P frame, macro blocks may refer to the I frame or the previous P frame. If no I or P frame can be referred, the P frame is internally encoded. In the B frame, the macro blocks may refer to a previous frame, a next frame, or both the previous and next frames. Additionally, the macro blocks in the B frame may also be internally encoded. The I frame has macro blocks encoded internally. The P frame has macro blocks referred to the previous frame or encoded internally. The B frame is not limited, and has macro blocks referred to the previous frame, the next frame, the both previous and next frames, or encoded internally. In MPEG, a sequence of video frames forms a sequence of GOP (Group Of Pictures), wherein a GOP begins with an I frame, and follows with an arrangement of P and B frames. In a MPEG movie, the processing unit 320 can determine the number and order of the I, P and B frames in advance. Generally, several B frames are inserted between two P frames, and the group of P and B frames are within two I frames, or between an I frame and a P frame. FIG. 5 is a schematic diagram illustrating the frame order in MPEG, wherein two P frames follows an I frame, and three groups of two B frames are respectively inserted between the I and P frames. It is noted that MPEG is only an example in this embodiment, and is not limited. Any encoding algorithm and type, such as MPEG 4, H263, H264 and others can be also applied in the invention.

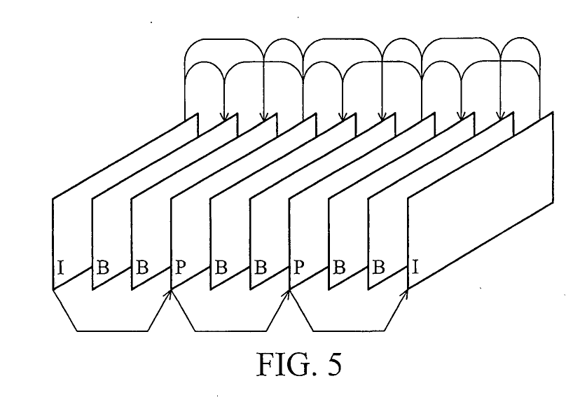

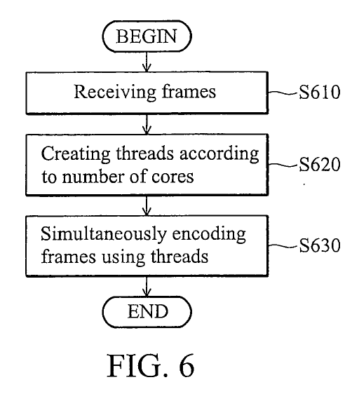

FIG. 6 is a flowchart of an embodiment of a rate control method according to the invention.

In step S610, a sequence of frames is received. In step S620, the number of core supported by a video encoding device is detected, and a plurality of threads is created according to the number of the core of the video encoding device. In step S630, at least one of the received frames is simultaneously encoded using the threads. It is understood that the encoding for frames can use various encoding algorithms, such as MPEG algorithm, and related details are omitted for brevity.

It is also understood that, when several threads are employed to simultaneously encode frames, the frame results after VLC (Variable Length Coding) can be fed back for subsequent rate control.

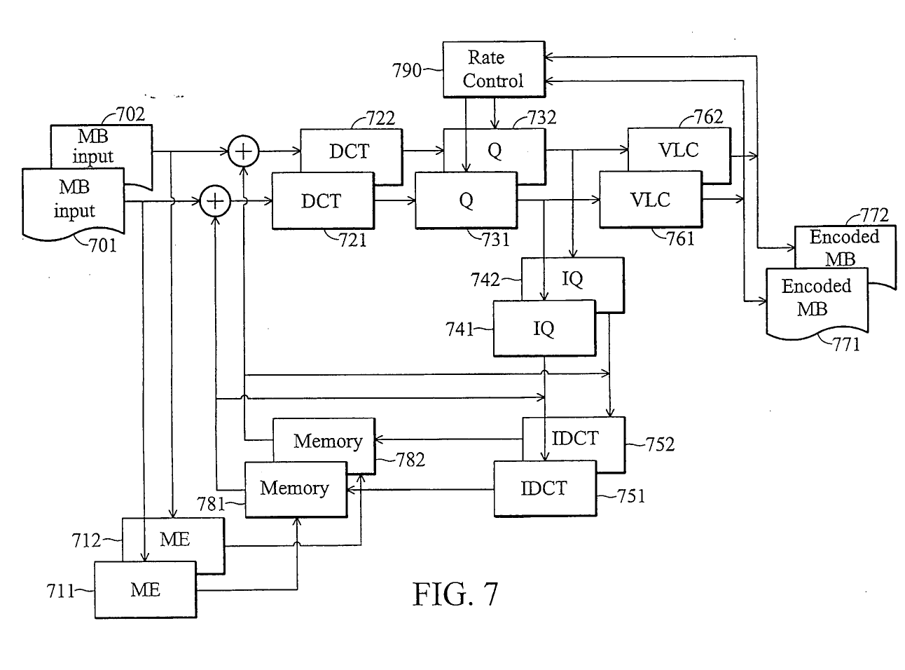

FIG. 7 is a schematic diagram illustrating an embodiment of encoding according to the rate control method of the invention. In this embodiment, two threads can be employed to simultaneously encode macro blocks in respective frames. The encoding procedure is composed of ME (Motion Estimation) 711 and 712, DCT (Discrete Cosine Transform) 721 and 722, Q (Quantization) 731 and 732, IQ (Inverse Quantization) 741 and 742, IDCT (Inverse Discrete Cosine Transform) 751 and 752, and VLC (Variable Length Coding) 761 and 762. During the encoding process, MBs (micro blocks) 701 and 702 of two frames are respectively input to ME 711 and 712 for motion estimation, and calculation of prediction error between the MB and a reference MB in the frame memory 781 and 782. The prediction errors of respective MBs are respectively input to DCT 721 and 722, and the DCT results of the MBs are respectively output to Q 731 and 732. The rate control 790 of the application will determine and output an appropriate Q value to Q 731 and 732 to quantize the results (DCT coefficients) corresponding to respective MBs received from the DCT 721 and 722. A better NSR (Noise to Signal Ratio) can be obtained using the Q value in quantization. Thereafter, the quantized coefficients are passed to IQ 741 and 742, and IDCT 751 and 752, thus to respectively recover the reference MBs in the memory. Finally, the quantized coefficients corresponding to two MBs 701 and 702 are respectively encoding via VLC 761 and 762 to obtain encoded MB 771 and 772. It is understood that, the results corresponding to MBs 701 and 702 after VLC 761 and 762 will be feed back to the rate control 790 to determine the Q value described above. In some embodiments, with the rate control considering the encoding situations of two MBs, the use of encoding bits is more efficient and flexible. For example, when the MB in one frame uses less encoding bits, the remnant encoding bits can be provided to the MB in another frame. It is noted the encoding of two MBs is an example in this embodiment, and is not limited, and the encoding of two or more MBs can be also applied in the application.

It is understood that the number of threads and the frames for respective threads for encoding can be arbitrarily designed according to various requirements. Several examples follow.

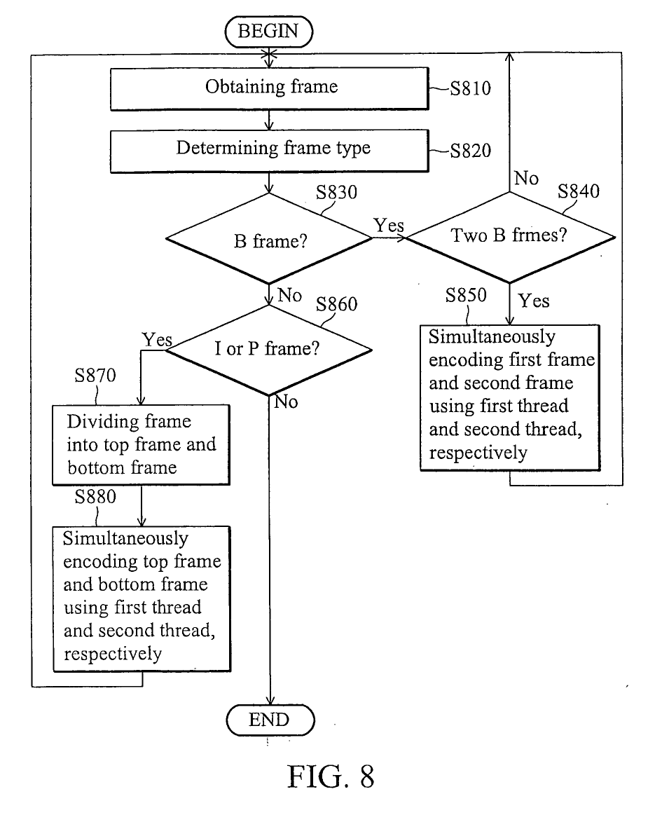

FIG. 8 is a flowchart of an embodiment of an example of rate control according to the invention. In this example, the number of core is 2 and the number of created threads is 2.

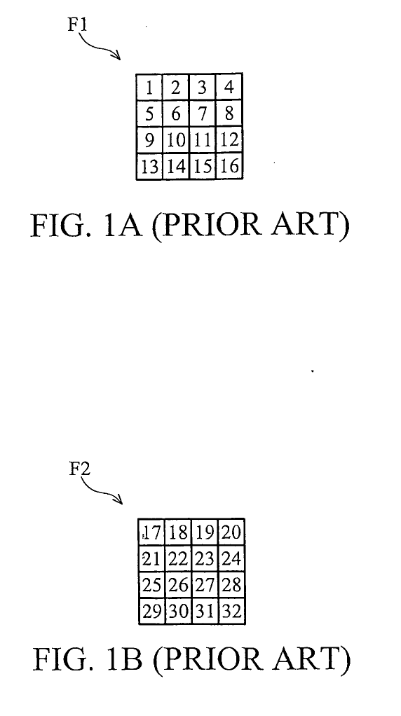

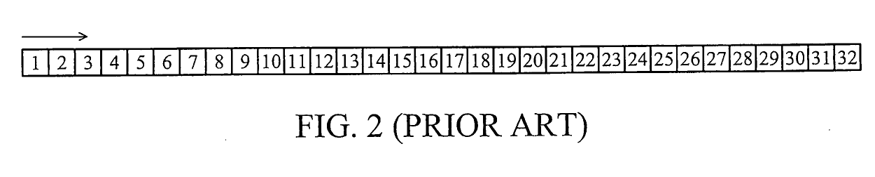

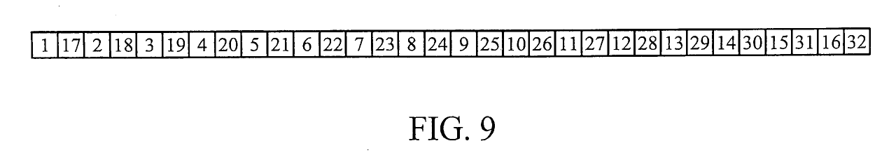

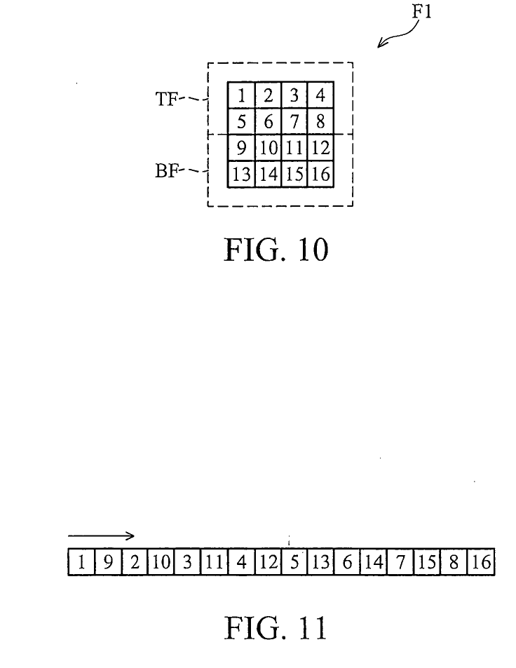

In step S810, a frame is obtained from the received frames. In step S820, the frame type of the frame is determined. If the frame is a B frame (Yes in step S830), in step S840, it is determined whether two B frames have been obtained. If not (No in step S840), the procedure returns to step S810 to obtain another frame. If two B frames have been received (Yes in step S840), in step S850, the two frames are simultaneously encoded by a first thread and a second thread, respectively. As described, when two threads simultaneously encode MBs of different frames, the results corresponding to the MBs of two frames after VLC will be fed back to the rate control to determine the Q value for subsequent encoding of MBs. Compared to the encoding order in FIG. 2 for the frames in the FIGS. 1A and 1B in conventional rate control, the rate control of this embodiment alternately encodes frames F1 and F2. In this embodiment, the encoding order of macro blocks is macro block 1 of frame F1, macro block 17 of frame F2, macro block 2 of frame F1, macro block 18 of frame F2, . . . , macro block 15 of frame F1, macro block 31 of frame F2, macro block 16 of frame F1, and macro block 32 of frame F2, as shown in FIG. 9. Thereafter, the procedure returns to step S810, another frame is obtained for subsequent encoding procedure. If the frame is not a B frame (No in step S830), but an I or P frame (Yes in step S860), in step S870, the frame is divided into a top frame and a bottom frame, and in step S880, the top frame and the bottom frame are simultaneously encoded by the first thread and the second thread, respectively. It is understood that the top frame and the bottom frame are independent, that is, no reference exists between the top frame and the bottom frame. In some embodiments, the frame can be divided according to a unit of slice. FIG. 10 is a schematic diagram illustrating an embodiment of a top frame and a bottom frame of a frame according to the invention. As shown in FIG. 10, frame F1 is divided into a top frame TF and a bottom frame BF, wherein the top frame TF and the bottom frame BF are independent each other. When the top frame TF and the bottom frame BF are simultaneously encoded by two threads, respectively, the encoding order of macro blocks is macro block 1 of the top frame TF, macro block 9 of the bottom frame BF, macro block 2 of the top frame TF, macro block 10 of the bottom frame BF, . . . , macro block 7 of the top frame TF, macro block 15 of the bottom frame BF, macro block 8 of the top frame TF, and macro block 16 of the bottom frame BF, as shown in FIG. 11. Similarly, when two threads simultaneously encode MBs of the top frame and the bottom frame, the results corresponding to the MBs of the top frame and the bottom frame after VLC will be fed back to the rate control to determine the Q value for subsequent encoding of MBs. Thereafter, the procedure returns to step S810, another frame is obtained for subsequent encoding procedure. It is noted that if the obtained frame is not one of the I, P or B frame, the encoding procedure fails, the procedure is finished.

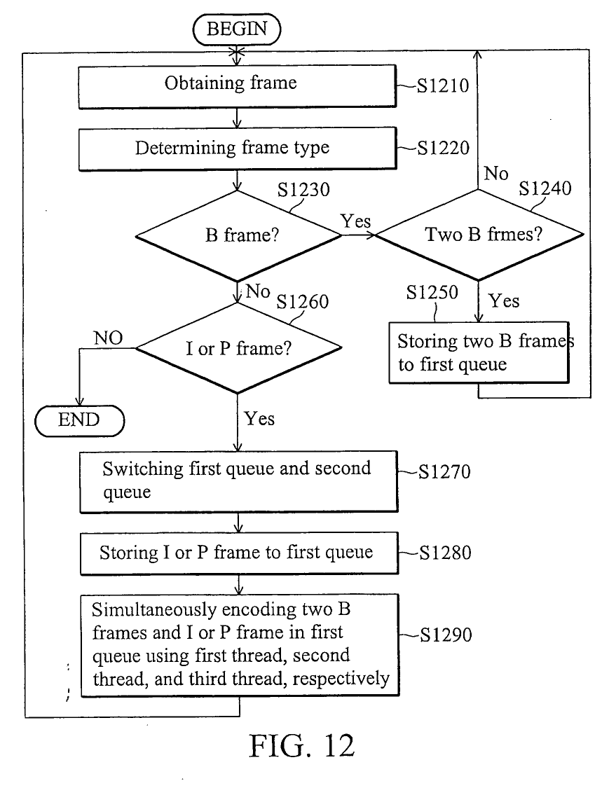

FIG. 12 is a flowchart of an embodiment of an example of rate control according to the invention. In this example, the number of core is 4 and the number of created threads is 3.

In step S1210, a frame is obtained from the received frames. In step S1220, the frame type of the frame is determined. If the frame is a B frame (Yes in step S1230), in step S1240, it is determined whether two B frames have been obtained. If not (No in step S1240), the procedure returns to step S1210 to obtain another frame. If two B frames have been received (Yes in step S1240), in step S1250, the two B frames are stored to the first queue 331 of the storage unit 330. Thereafter, the procedure returns to step S1210. If the frame is not a B frame (No in step S1230), but an I or P frame (Yes in step S1260), in step S1270, the first queue 331 and the second queue 332 of the storage unit 330 are switched. It is noted that at least a subsequent frame of the received frames will be stored to the second queue 332 for subsequent encoding procedure. It is also noted that, in this embodiment, the two queues alternately stores the frames or small units of frame for encoding. In some embodiments, however, multiple queues can be employed to store the frames/small units of frame. Additionally, in some embodiments, the frames/small units of frame can be directly stored to the storage unit without the use of queue. Then, in step S1280, the I or P frame is stored to the first queue 331, and in step S1290, the two B frames and the I or P frame in the first queue 331 are simultaneously encoded by a first thread, a second thread, and a third thread, respectively. Similarly, when three threads simultaneously encode MBs of the two B frames and the I or P frame, the results corresponding to the MBs of the two B frames and the I or P frame after VLC will be fed back to the rate control to determine the Q value for subsequent encoding of MBs. Thereafter, the procedure returns to step S1210, another frame is obtained for subsequent encoding procedure. It is noted that if the obtained frame is not one of the I, P or B frame, the encoding procedure fails, and the procedure is finished.

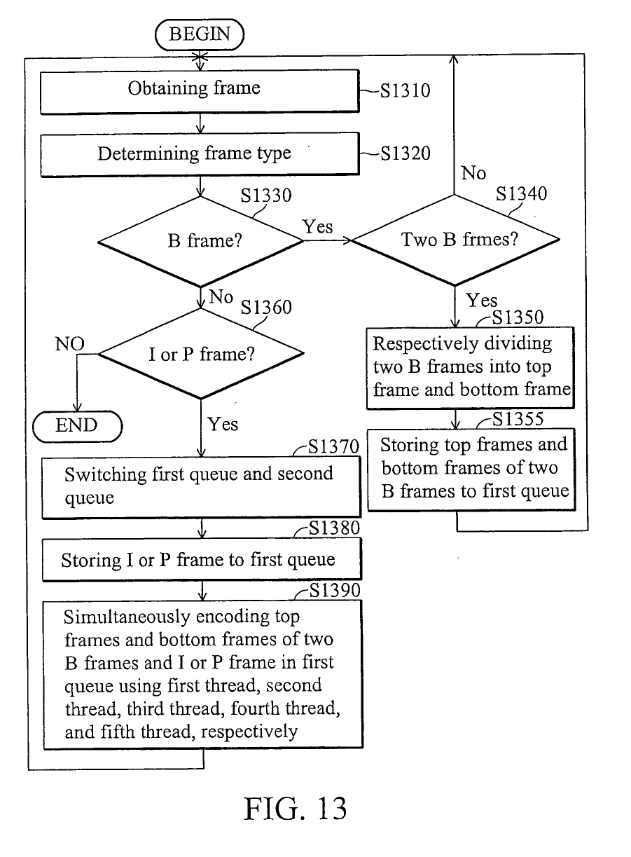

FIG. 13 is a flowchart of an embodiment of an example of rate control according to the invention. In this example, the number of core is 4 and the number of created threads is 5.

In step S1310, a frame is obtained from the received frames. In step S1320, the frame type of the frame is determined. If the frame is a B frame (Yes in step S1330), in step S1340, it is determined whether two B frames have been obtained. If not (No in step 1340), the procedure returns to step S1310 to obtain another frame. If two B frames have been received (Yes in step S1340), in step S1350, the two B frames respectively divided into a top frame and a bottom frame, and in step S1355, the top frames and the bottom frames of the two B frames are stored to the first queue 331 of the storage unit 330. Thereafter, the procedure returns to step S1310. If the frame is not a B frame (No in step S1330), but an I or P frame (Yes in step S1360), in step S1370, the first queue 331 and the second queue 332 of the storage unit 330 are switched. Similarly, at least a subsequent frame of the received frames will be stored to the second queue 332 for subsequent encoding procedure. Then, in step S1380, the I or P frame is stored to the first queue 331, and in step S1390, the top frames and the bottom frames of the two B frames and the I or P frame in the first queue 331 are simultaneously encoded by a first thread, a second thread, a third thread, and a fourth thread, respectively. Similarly, when five threads simultaneously encode MBs of the top frames and the bottom frames of the two B frames and the I or P frame, the results corresponding to the MBs of the top frames and the bottom frames of the two B frames and the I or P frame after VLC will be fed back to the rate control to determine the Q value for subsequent encoding of MBs. Thereafter, the procedure returns to step S1310, and another frame is obtained for subsequent encoding procedure. It is noted that if the obtained frame is not one of the I, P or B frame, the encoding procedure fails, and the procedure is finished.

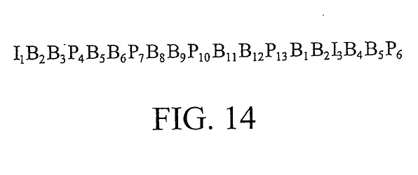

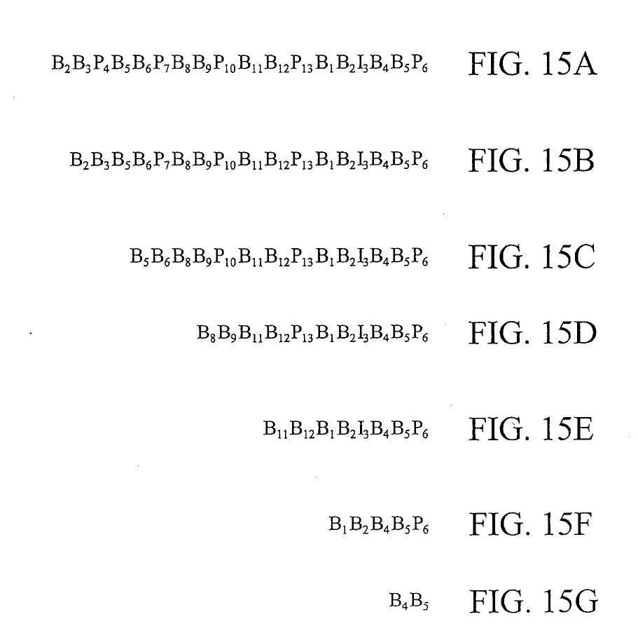

FIG. 14 is a schematic diagram illustrating an example of MPEG frames, wherein I, B, and P represent the I, B and P frames, respectively. First, frame I₁ is read and encoded. The remnant frames are shown in FIG. 15A. Frame P₄ is read and encoded. The remnant frames are shown in FIG. 15B. Then, frames B₂, B₃, and P₇ are read and encoded. The remnant frames are shown in FIG. 15C. Frames B₅, B₆, and P₁₀ are read and encoded. The remnant frames are shown in FIG. 15D. Frames B₈, B₉, and P₁₃ are read and encoded. The remnant frames are shown in FIG. 15E. Frames B₁₁, B₁₂, and I₃ are read and encoded. The remnant frames are shown in FIG. 15F. Frames B₁, B₂, and P₆ are read and encoded. The remnant frames are shown in FIG. 15G. Finally, frames B₄ and B₅ are read and encoded, thus completing the entire encoding procedure.

It is understood that since different encoding algorithms may have different frame definitions and corresponding encoding orders, the number of threads created by the video encoding device supporting multiple cores, and the processing order for frames can be arbitrarily adjusted according to different encoding algorithms and requirements. The invention is not limited to the examples in the above embodiments.

Rate control method and devices, or certain aspects or portions thereof, may take the form of a program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A rate control method for use in a video encoding device supporting at least one core, comprising:
receiving a sequence of frames;
creating a plurality of threads according to the number of the at least one core of the video encoding device;
employing the threads to encode at least one frame of the received frames, simultaneously; and
encoding the frames in the sequence according to the encoding results corresponding to the at least one frame.

2. The method of claim 1 further comprising:
determining the frame type of a first frame;
obtaining a second frame if the first frame is a B frame, wherein the second frame is a B frame; and
simultaneously encoding the first frame and the second frame using a first thread and a second thread, respectively.

3. The method of claim 1 further comprising:
determining the frame type of a first frame;
dividing the first frame into a top frame and a bottom frame if the first frame is an I or P frame; and
simultaneously encoding the top frame and the bottom frame using a first thread and a second thread, respectively.

4. The method of claim 1 further comprising:
determining the frame type of a first frame;
obtaining a second frame if the first frame is a B frame, wherein the second frame is a B frame;
determining the frame type of a third frame; and
if the third frame is an I or P frame, simultaneously encoding the first frame, the second frame, and the third frame using a first thread, a second thread, and a third thread, respectively.

5. The method of claim 1 further comprising:
determining the frame type of a first frame;
obtaining a second frame if the first frame is a B frame, wherein the second frame is a B frame;
respectively dividing the first frame and the second frame into a top frame and a bottom frame;
determining the frame type of a third frame; and
if the third frame is an I or P frame, simultaneously encoding the top frame and bottom frame of the first frame, the top frame and bottom frame of the second frame, and the third frame using a first thread, a second thread, a third thread, a fourth thread, and a fifth thread, respectively.

6. The method of claim 1 further comprising:
determining a quantization value according to the encoding results corresponding to a first macro block of a first frame and a second macro block of a second frame among the at least one frame; and
performing a quantization process on a third macro block of the first frame and a fourth macro block of the second frame according to the quantization value.

7. A rate control device supporting at least one core, comprising:
a reception unit receiving a sequence of frames; and
a processing unit creating a plurality of threads according to the number of the at least one core of the video encoding device, employing the threads to encode at least one frame of the received frames, simultaneously, and encoding the frames in the sequence according to the encoding results corresponding to the at least one frame.

8. The device of claim 7, wherein the processing unit further determines the frame type of a first frame, obtains a second frame if the first frame is a B frame, wherein the second frame is a B frame, and simultaneously encodes the first frame and the second frame using a first thread and a second thread, respectively.

9. The device of claim 7, wherein the processing unit further determines the frame type of a first frame, divides the first frame into a top frame and a bottom frame if the first frame is an I or P frame, and simultaneously encodes the top frame and the bottom frame using a first thread and a second thread, respectively.

10. The device of claim 7, wherein the processing unit further determines the frame type of a first frame, obtains a second frame if the first frame is a B frame, wherein the second frame is a B frame, determines the frame type of a third frame, and simultaneously encodes the first frame, the second frame, and the third frame using a first thread, a second thread, and a third thread, respectively, if the third frame is an I or P frame.

11. The device of claim 7, wherein the processing unit further determines the frame type of a first frame, obtains a second frame if the first frame is a B frame, wherein the second frame is a B frame, respectively divides the first frame and the second frame into a top frame and a bottom frame, determines the frame type of a third frame, and simultaneously encodes the top frame and bottom frame of the first frame, the top frame and bottom frame of the second frame, and the third frame using a first thread, a second thread, a third thread, a fourth thread, and a fifth thread, respectively, if the third frame is an I or P frame.

12. The device of claim 7, wherein the processing unit further determines a quantization value according to the encoding results corresponding to a first macro block of a first frame and a second macro block of a second frame among the at least one frame, and performs a quantization process on a third macro block of the first frame and a fourth macro block of the second frame according to the quantization value.
